(19) United States
(12) Patent Application Publication
(10) Pub. No.: US 2014/0331164 A1
(43) Pub. Date: Nov. 6, 2014

(54) TERMINAL APPARATUS, READING PROCESSING SYSTEM, AND NON-TRANSITORY COMPUTER READABLE MEDIUM

(71) Applicant: FUJI XEROX CO., LTD., Tokyo (JP)

(72) Inventors: Hiroyuki ENOMOTO, Kanagawa (JP); Tetsuya KOBAYASHI, Kanagawa (JP); Teppei AOKI, Kanagawa (JP); Tadaaki SATO, Kanagawa (JP); Hidetoshi KAKOI, Yokohama-shi (JP)

(73) Assignee: FUJI XEROX CO., LTD., Tokyo (JP)

(21) Appl. No.: 14/064,754

(22) Filed: Oct. 28, 2013

(30) Foreign Application Priority Data
May 1, 2013 (JP) 2013-096528

(51) Int. Cl. G06F 3/0481

(52) U.S. Cl. CPC G06F 3/04817
USPC 715/771

(57) ABSTRACT

A terminal apparatus includes an acceptance unit, a memory, a display, and a transmitter. The acceptance unit accepts an operation. The memory stores a reading condition for executing a reading process. The display displays multiple icons for an individual reading condition, the multiple icons representing the individual reading condition. In a case where the acceptance unit accepts an operation for selecting one of the multiple icons, the transmitter transmits instruction data for instructing that a reading process be performed under the reading condition corresponding to the selected icon to an external reading apparatus which is to execute the reading process.

### CROSS-REFERENCE TO RELATED APPLICATIONS

This application is based on and claims priority under 35 USC 119 from Japanese Patent Application No. 2013-096528 filed May 1, 2013.

### BACKGROUND

### Technical Field

The present invention relates to a terminal apparatus, a reading processing system, and a non-transitory computer readable medium.

### SUMMARY

According to an aspect of the invention, there is provided a terminal apparatus including an acceptance unit, a memory, a display, and a transmitter. The acceptance unit accepts an operation. The memory stores a reading condition for executing a reading process. The display displays multiple icons for an individual reading condition, the multiple icons representing the individual reading condition. In a case where the acceptance unit accepts an operation for selecting one of the multiple icons, the transmitter transmits instruction data for instructing that a reading process be performed under the reading condition corresponding to the selected icon to an external reading apparatus which is to execute the reading process.

### BRIEF DESCRIPTION OF THE DRAWINGS

An exemplary embodiment of the present invention will be described in detail based on the following figures, wherein:

FIG. 1 illustrates an overall configuration of an information processing system according to an exemplary embodiment of the present invention; and

FIG. 2 is a block diagram illustrating a hardware configuration of an image forming apparatus according to the exemplary embodiment;

FIG. 3 is a block diagram illustrating a hardware configuration of a terminal apparatus according to the exemplary embodiment;

FIG. 4 illustrates an example configuration of a registered condition DB according to the exemplary embodiment;

FIGS. 5A and 5B illustrate operation screens displayed on the terminal apparatus according to the exemplary embodiment;

FIG. 6 is a block diagram illustrating a functional configuration of the terminal apparatus and the image forming apparatus according to the exemplary embodiment;

FIG. 7 is a sequence diagram illustrating the processing flow in the information processing system according to the exemplary embodiment;

FIG. 8 is a flowchart illustrating the flow for an inquiry process according to the exemplary embodiment;

FIG. 9 illustrates an operation screen displayed on the terminal apparatus according to the exemplary embodiment;

FIG. 10 is a flowchart illustrating the flow for a registration process for registering a processing condition according to the exemplary embodiment;

FIGS. 11A to 11D illustrate transitions of screens in the registration process according to the exemplary embodiment;

FIGS. 12A and 12B illustrate transitions of screens in the registration process according to the exemplary embodiment;

FIG. 13 illustrates a My Favorites screen displayed on the terminal apparatus according to the exemplary embodiment;

FIG. 14 illustrates the relationships between object images and processing parameters according to the exemplary embodiment;

FIGS. 15A to 15D illustrate display elements forming an object image according to the exemplary embodiment;

FIG. 16 is a sequence diagram illustrating the flow for processing performed in the information processing system according to the exemplary embodiment;

FIGS. 17A to 17C illustrate a My Favorites screen displayed on a terminal apparatus according to an exemplary modification of the present invention;

FIG. 18 illustrates transitions of a My Favorites screen according to the exemplary modification;

FIGS. 19A and 19B illustrate other examples of the My Favorites screen according to the exemplary modification; and

FIG. 20 illustrates an example configuration of a registered condition DB according to the exemplary modification.

### DETAILED DESCRIPTION

An exemplary embodiment of the present invention will be described with reference to the drawings. A terminal apparatus according to an exemplary embodiment of the present invention will be described in the context of a terminal apparatus 10 configured to instruct an image forming apparatus 20 to execute information processing.

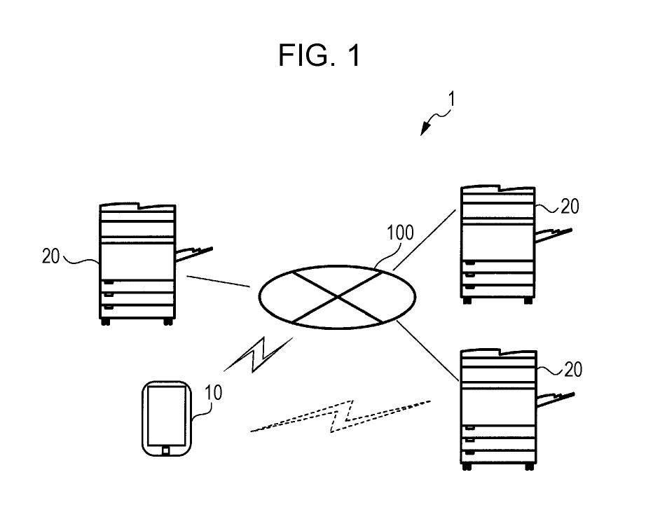

FIG. 1 illustrates an overall configuration of an information processing system 1. As illustrated in FIG. 1, the information processing system 1 includes a terminal apparatus 10 and multiple image forming apparatuses 20. The terminal apparatus 10 and the multiple image forming apparatuses 20 are connected to a communication line 100. The communication line 100 may be, for example, a communication line including a wireless local area network (LAN) or a Wi-Fi (registered trademark) network.

In FIG. 1, one terminal apparatus 10 is illustrated; however, more than one terminal apparatus 10 may be used. In addition, three image forming apparatuses 20 are illustrated in FIG. 1; however, more than or less than three image forming apparatuses 20 may be used.

The terminal apparatus 10 is configured to instruct one of the image forming apparatuses 20 to execute information processing via the communication line 100. The terminal apparatus 10 instructs that information processing such as copying, scanning, or facsimile transmission be executed. The terminal apparatus 10 may be, for example, a smartphone. Each of the image forming apparatuses 20 may be an example of an information processing apparatus according to an exemplary embodiment of the present invention, and is configured to execute information processing such as copying, scanning, or facsimile transmission. The image forming apparatuses 20 have each functions for executing information processing specified by a user operating the terminal apparatus 10 and for executing information processing specified by a user directly operating the image forming apparatuses 20.

The terminal apparatus 10 may also be any other terminal apparatus such as a mobile phone terminal, a tablet terminal, a notebook personal computer, a personal digital assistant (PDA), or a mobile game console. As indicated by the broken line in FIG. 1, the terminal apparatus 10 and the image forming apparatuses 20 may directly communicate with one another using, for example, ad-hoc mode in wireless LAN connection or the like.

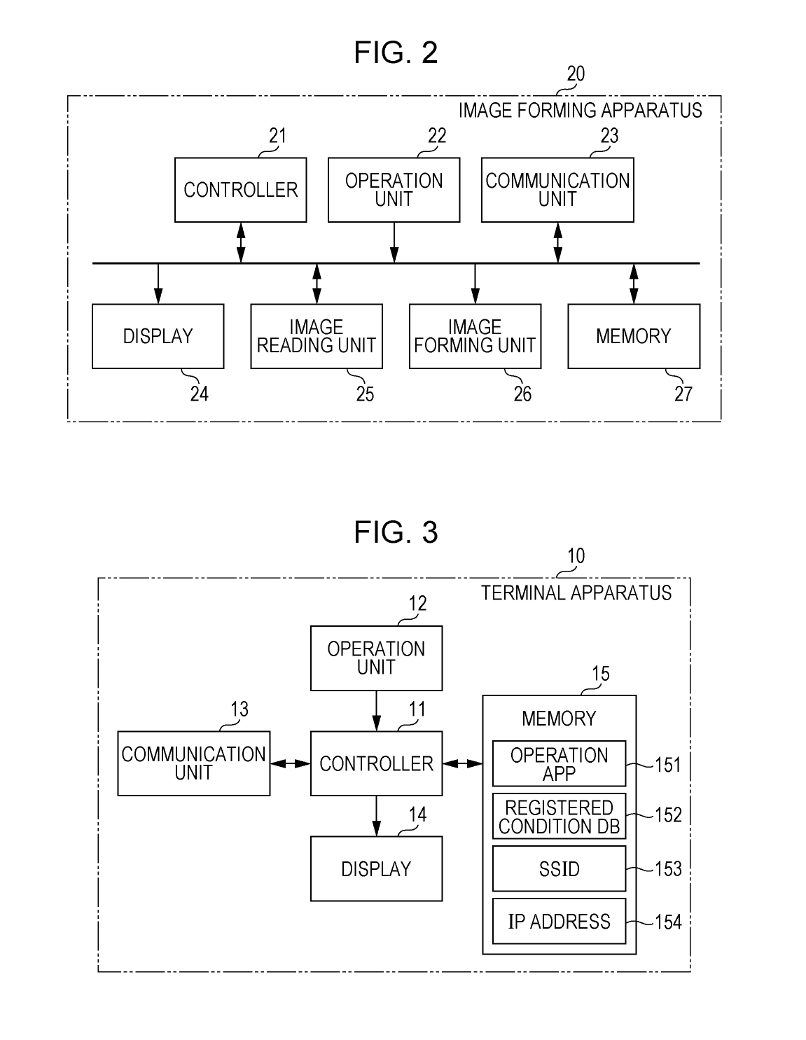

FIG. 2 is a block diagram illustrating a hardware configuration of each of the image forming apparatuses 20. As illustrated in FIG. 2, each of the image forming apparatuses 20 includes a controller 21, an operation unit 22, a communication unit 23, a display 24, an image reading unit 25, an image forming unit 26, and a memory 27.

The controller 21 may be a control device including a computing device including a central processing unit (CPU) and an application specific integrated circuit (ASIC), and a memory, and is configured to control the individual units of the image forming apparatus 20. The operation unit 22 may be an operation device configured to accept an operation performed by the user, and includes, for example, a touch screen and physical keypads. The touch screen and the physical keypads are provided so as to be superimposed on a display surface of the display 24. The communication unit 23 may be an interface configured to connect to the communication line 100, a telephone line (not illustrated), or the Internet for communication. For example, the communication unit 23 transmits data to the terminal apparatus 10 via the communication line 100, or receives data from the terminal apparatus 10 via the communication line 100. The display 24 may be, for example, a liquid crystal display, and is configured to display various images (or screens) on the display surface on which an image is displayed to present information to the user. The image reading unit 25 may be, for example, a scanner, and is configured to read an image on a document. The image reading unit 25 supplies image data indicating the read image to the controller 21. The image forming unit 26 may be a printer configured to form an image on a sheet such as a piece of paper using, for example, an electrophotographic process. The memory 27 may be a storage device including, for example, a hard disk device, and stores a control program to be executed by the controller 21.

In each of the image forming apparatuses 20 having the configuration described above, in order to execute a copying process, the controller 21 causes the image reading unit 25 to read an image on a document. Then, the controller 21 causes the image forming unit 26 to form an image based on the image data generated by the image reading unit 25 on a sheet. In each of the image forming apparatuses 20, in order to execute a scanning process, the controller 21 causes image data generated by the image reading unit 25 to be stored in the memory 27 or to be transmitted through the communication unit 23. In the latter case, the controller 21 may transmit the image data, which is obtained as a result of scanning, to the terminal apparatus 10 that has made an instruction to execute the information processing. In each of the image forming apparatuses 20, in order to execute a facsimile transmission process, the controller 21 causes the communication unit 23 to transmit image data generated by the image reading unit 25 via facsimile using a telephone line (not illustrated).

FIG. 3 is a block diagram illustrating a hardware configuration of the terminal apparatus 10. As illustrated in FIG. 3, the terminal apparatus 10 includes a controller 11, an operation unit 12, a communication unit 13, a display 14, and a memory 15.

The controller 11 includes a microcomputer having a CPU, a read only memory (ROM), and a random access memory (RAM). The CPU loads a program stored in the ROM or the memory 15 into the RAM and executes the program to control the individual units of the terminal apparatus 10. The operation unit 12 may be an operation device configured to accept an operation performed by the user, and includes, for example, a touch screen and physical keypads. The touch screen and physical keypads are provided so as to be superimposed on a display surface of the display 14. The communication unit 13 includes an interface configured to connect to the communication line 100 or a communication network (not illustrated) such as a mobile communication network for communication. For example, the communication unit 13 transmits data to the image forming apparatuses 20 via the communication line 100, or receives data from the image forming apparatuses 20 via the communication line 100. The display 14 may be, for example, a liquid crystal display, and is configured to display various images (or screens) on the display surface on which an image is displayed to present information to the user.

The memory 15 includes a storage device such as an electronically erasable and programmable ROM (EEPROM) or a flash memory, and stores, for example, an operation application (app) 151, a registered condition database (DB) 152, a service set identifier (SSID) 153, and an Internet protocol (IP) address 154. The operation app 151 is an application program operating on, for example, an operating system (OS) of the terminal apparatus 10. The controller 11 executes the operation app 151 to implement the function for instructing one of the image forming apparatuses 20 to execute information processing. The registered condition DB 152 is a database that stores processing conditions in accordance with which the image forming apparatus 20 executes the information processing. The terminal apparatus 10 has a function for registering a processing condition that has been specified by the user in the registered condition DB 152 for the purpose of future use of the processing condition.

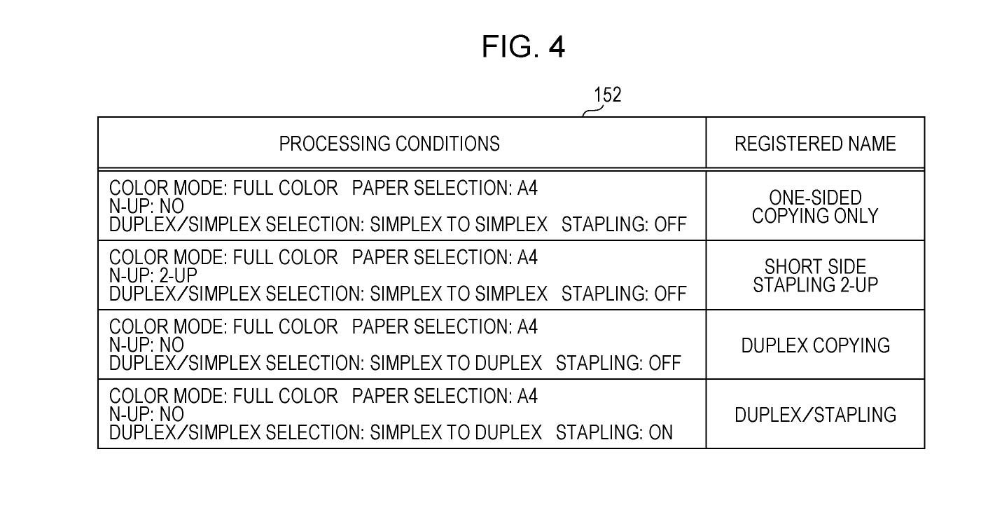

FIG. 4 illustrates an example configuration of the registered condition DB 152. As illustrated in FIG. 4, the registered condition DB 152 is a data table in which processing conditions and registered names are associated with each other. A processing condition includes multiple processing parameters which are used for information processing. A description will be given here of processing parameters for the copying process, by way of example. As illustrated in FIG. 4, in this exemplary embodiment, the processing parameters for the copying process include five parameters, “color mode”, “paper selection”, “N-up”, “duplex/simplex selection”, and “stapling”.

“Color mode” is a condition indicating the type of toners with which the image forming unit 26 is to form an image. The processing parameters for color mode include, for example, “full color”, “black and white”, and “automatic”. “Full color” indicates the use of all the toners possessed by the image forming unit 26. “Black and white” indicates the use of only black toner. “Automatic” indicates the use of the toner that is determined by the controller 21 in accordance with the color used in the document. “Paper selection” is a condition indicating the paper size with which the image forming unit 26 is to form an image. The processing parameters for paper selection include, for example, “A4”, indicating A4 paper size, “A3”, indicating A3 paper size, and “automatic”, indicating the paper size that is determined by the controller 11 in accordance with the size of the document. “N-up” is a condition indicating the number of pages of image data to be placed on each sheet. The processing parameters for N-up include, for example, “no N-up” indicating that multiple pages of images are not to be placed on each sheet (that is, one sheet is to be used for one page of image data), and “2-up” indicating that two pages of images are to be placed on each sheet. “Duplex/simplex selection” is a condition indicating a document surface to be scanned by the image reading unit 25 and a sheet surface on which the image forming unit 26 is to be form an image. The processing parameters for duplex/simplex selection include, for example, “simplex to simplex”, indicating that one side of a document is to be scanned and an image is to be formed on one side of a sheet, “simplex to duplex”, indicating that the front sides of documents are to be scanned and images are to be formed on two sides of a sheet, and “duplex to duplex”, indicating that two sides of a document are to be scanned and images are to be formed on two sides of a sheet. “Stapling” is a condition indicating whether sheets on which the image forming unit 26 has formed images are to be stapled together. The processing parameters for stapling include, for example, “ON” indicating that sheets are stapled together, and “OFF” indicating that sheets are not stapled together.

The registered name is the name of a processing condition registered in the registered condition DB 152. The registered name is a name set by the user, and is set to, for example, a name that helps the user readily identify the content of the processing condition. Examples of the name include a name that represents the summary of the processing condition, and a name that represents the purpose or use of the processing condition.

In the example configuration of the registered condition DB 152 illustrated in FIG. 4, four processing conditions are registered. Each field of the registered condition DB 152 is blank before the user initiates the registration of a processing condition.

The SSID 153 stored in the memory 15 includes an SSID that is currently used by the terminal apparatus 10 for communication using a Wi-Fi network, and an SSID that was being used by the terminal apparatus 10 when the terminal apparatus 10 instructed one of the image forming apparatuses 20 to execute information processing the previous time. An SSID is identification information that varies in accordance with the Wi-Fi area (communication area) where the terminal apparatus 10 is located. The IP address 154 includes an IP address currently assigned to the terminal apparatus 10, and an IP address assigned to the terminal apparatus 10 when the terminal apparatus 10 instructed one of the image forming apparatuses 20 to execute information processing the previous time. An IP address is a communication address indicating which access point the terminal apparatus 10 is connected to. That is, the SSID 153 and the IP address 154 are information that varies depending on the location where the terminal apparatus 10 is positioned.

The terminal apparatus 10 having the configuration described above is configured to display an operation screen on which an operation of the user is accepted in order to give an instruction to one of the image forming apparatuses 20 to execute information processing.

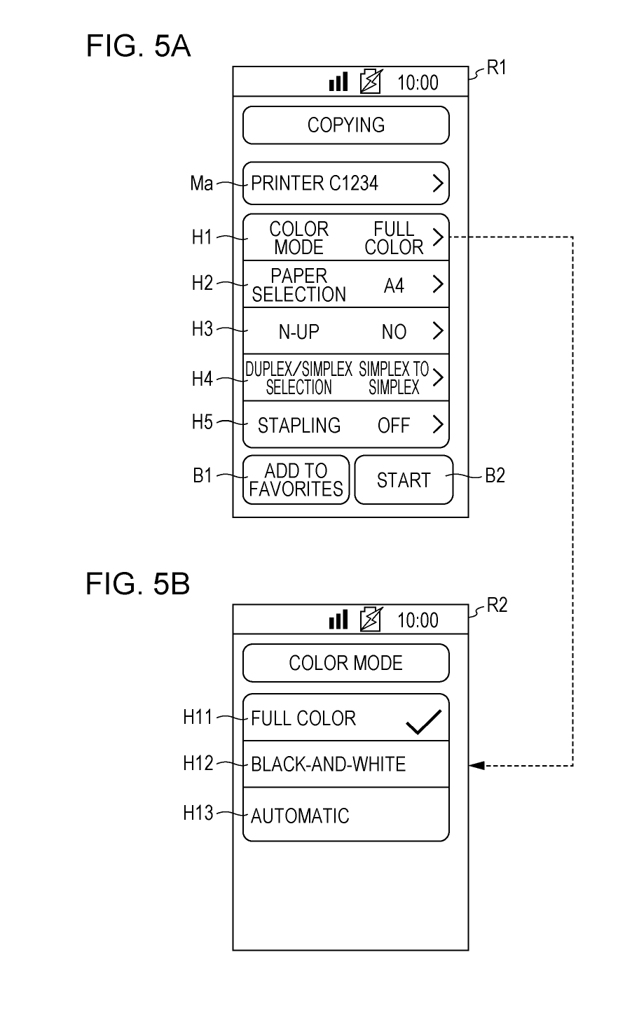

FIGS. 5A and 5B illustrate operation screens for the copying process, which are displayed on the terminal apparatus 10. FIG. 5A illustrates an operation screen R1 displayed on the terminal apparatus 10. As illustrated in FIG. 5A, the operation screen R1 includes a device setting field Ma and specification fields H1, H2, H3, H4, and H5. The device setting field Ma and the specification fields H1, H2, H3, H4, and H5 are arranged from the top to the bottom of the operation screen R1. The device setting field Ma is a field for setting a device to which the terminal apparatus 10 gives an instruction to execute information processing and to which instruction data is transmitted. In the example illustrated in FIG. 5A, the image forming apparatus 20 that is identified by “Printer C1234” is set as the default device. In each of the specification fields H1 to H5, the names of the processing parameters used for the copying process and the names of currently selected processing parameters are associated with each other. The specification field H1 corresponds to “color mode”, the specification field H2 to “paper selection”, the specification field H3 to “N-up”, the specification field H4 to “duplex/simplex selection”, and the specification field H5 to “stapling”.

When specifying a processing parameter, the user of the terminal apparatus 10 performs an operation of touching the position of the corresponding specification field with their finger while the operation screen R1 is being displayed. For example, when the user touches the specification field H1 with their finger, the terminal apparatus 10 makes a transition from the operation screen R1 illustrated in FIG. 5A to an operation screen R2 illustrated in FIG. 5B. The operation screen R2 is a screen for specifying the processing parameters for the processing condition “color mode”. As illustrated in FIG. 5B, the operation screen R2 includes specification fields H11, H12, and H13 that are arranged from the top to the bottom of the operation screen R2. The specification fields H11, H12, and H13 correspond to options of the processing parameters. Specifically, the specification field H11 corresponds to the processing parameter “full color”, the specification field H12 to the processing parameter “black and white”, and the specification field H13 to the processing parameter “automatic”. In the example illustrated in FIG. 5B, the specification field H11 is marked with a check mark indicating that the processing parameter “full color” has been selected. When the user desires to change a processing parameter, they touch one of the specification fields H11 to H13 corresponding to the desired processing parameter with their finger.

The terminal apparatus 10 also accepts the selection of the processing parameters for processing conditions other than “color mode”. In this case, when the user selects a specification field included in the operation screen R1, the terminal apparatus 10 makes a transition to a screen including processing parameter options, and accepts the specification of a processing parameter. The operation screens corresponding to the respective processing conditions, the operations to be performed by the user, and so forth will be anticipated from the description of “color mode”, and will not be described herein.

After the setting of processing parameters is completed, the user of the terminal apparatus 10 touches a soft button B2 marked “Start” with their finger. When the soft button B2 is operated by the user, the terminal apparatus 10 instructs the image forming apparatus 20 to execute a copying process in accordance with the set processing condition via the communication line 100.

When a soft button B1 marked “Add to favorites” is selected by the user, the terminal apparatus 10 registers therein the processing condition specified by the user. For example, the terminal apparatus 10 may perform a registration process for registering a processing condition including multiple processing parameters which is being displayed on the operation screen R1 by creating a new record in the registered condition DB 152. The terminal apparatus 10 is configured such that a processing condition registered in the registered condition DB 152 may be specified with a smaller amount of operation than that when the user directly specifies the processing condition.

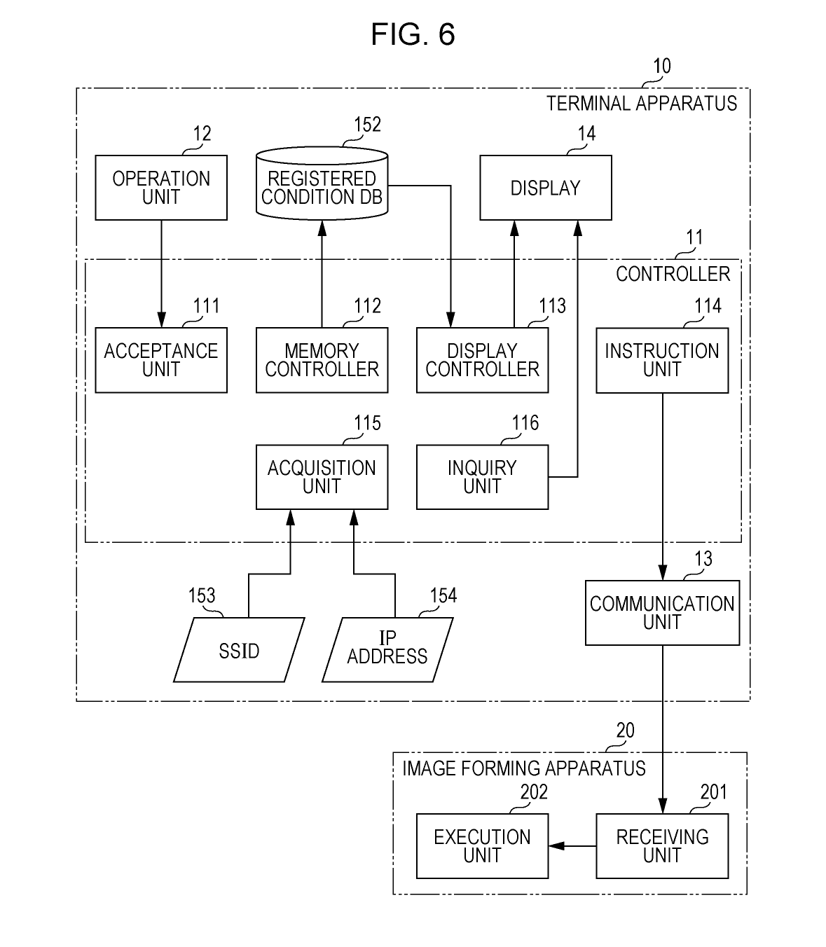

FIG. 6 is a block diagram illustrating a functional configuration of the terminal apparatus 10 and each of the image forming apparatuses 20. As illustrated in FIG. 6, the controller 11 of the terminal apparatus 10 executes the operation app 151 to implement the functions of an acceptance unit 111, a memory controller 112, a display controller 113, an instruction unit 114, an acquisition unit 115, and an inquiry unit 116. Each of the image forming apparatuses 20 executes a control program to implement the functions of a receiving unit 201 and an execution unit 202.

The acceptance unit 111 of the terminal apparatus 10 accepts an operation performed by the user. By way of example, the acceptance unit 111 acquires an operation signal from the operation unit 12, and accepts an operation indicated by the operation signal.

When the acceptance unit 111 accepts an operation for specifying a processing condition indicating information processing, the memory controller 112 stores the specified processing condition in the memory 15. By way of example, the memory controller 112 registers a processing condition including the processing parameters specified by the user using the operation screens R1 and R2 and so forth by newly writing the processing condition to the registered condition DB 152.

The display controller 113 causes the display 14 to display an object image (for example, icon image) associated with each of the processing conditions registered in the registered condition DB 152. More specifically, the display controller 113 causes the display 14 to display an object image uniquely associated with multiple processing parameters included in a processing condition. By way of example, the display controller 113 makes the object images differ depending on the combination of parameters included in the processing condition.

In a case where an operation for selecting an object image displayed on the display 14 is accepted by the acceptance unit 111, the instruction unit 114 outputs instruction data for instructing that information processing be executed in accordance with the processing condition corresponding to the object image. The instruction unit 114 acquires a processing condition registered in the registered condition DB 152. Then, the instruction unit 114 transmits and outputs the instruction data to one of the image forming apparatuses 20 via the communication line 100 using the communication unit 13. The instruction data includes, for example, the type of information processing instructed to be executed and the processing parameters used for the information processing.

The receiving unit 201 of the image forming apparatus 20 receives the instruction data transmitted from the instruction unit 114. The execution unit 202 executes information processing based on the instruction data received by the receiving unit 201. The execution unit 202 identifies the type of information processing instructed to be executed and processing parameters in accordance with the instruction data, and executes the information processing.

The acquisition unit 115 of the terminal apparatus 10 reads the SSID 153 and the IP address 154 from the memory 15, and acquires the SSID 153 and the IP address 154.

In accordance with the SSID 153 and the IP address 154, if the SSID or IP address used when the operation for selecting the object image is accepted is different from that used when the selection operation was accepted the previous time, the inquiry unit 116 inquires of the user whether the output of the instruction data to the image forming apparatus 20 is acceptable.

If an operation for permitting the instruction data to be output is accepted by the acceptance unit 111 in response to the inquiry from the inquiry unit 116, the instruction unit 114 outputs the instruction data.

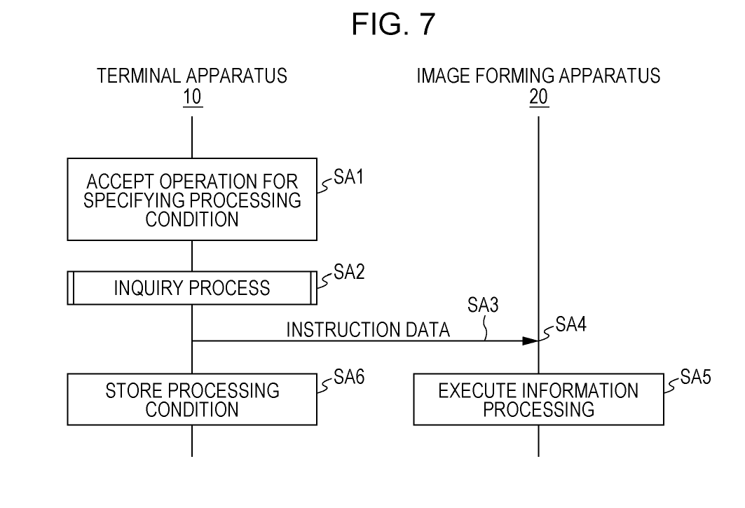

FIG. 7 is a sequence diagram illustrating the processing flow in the information processing system 1 in a case where the terminal apparatus 10 instructs one of the image forming apparatuses 20 to execute a copying process. It is assumed that processing conditions have not yet been registered in the registered condition DB 152 when the following operation starts.

First, the controller 11 of the terminal apparatus 10 accepts an operation for specifying a processing condition by the user operating the operation unit 12 (step SA1). In this case, the controller 11 accepts an operation for directly specifying multiple processing parameters included in the processing condition. It is assumed here that an operation screen obtained after the processing parameters have been specified is the operation screen R1 illustrated in FIG. 5A.

Then, the controller 11 executes an inquiry process (step SA2). The inquiry process is a process for inquiring of the user of the terminal apparatus 10 whether to instruct one of the image forming apparatuses 20 to execute information processing if specific conditions are satisfied. After the execution of the inquiry process, if it is determined that the user sends an instruction to the image forming apparatus 20 to execute information processing, the controller 11 transmits instruction data to the image forming apparatus 20 so that information processing is executed in accordance with the processing condition specified in the processing of step SA1 (step SA3). The destination to which the instruction data is sent is the image forming apparatus 20 set in the device setting field Ma. The instruction data may include any other information concerning the source or the terminal apparatus 10, such as the IP address.

Upon receiving the instruction data at the communication unit 23 (step SA4), the controller 21 of the image forming apparatus 20 executes the information processing instructed to be executed in accordance with the received instruction data (step SA5). In this case, the controller 21 controls the image reading unit 25 and the image forming unit 26 to execute a copying process in accordance with the processing condition specified by the instruction data.

After transmitting the instruction data in the processing of step SA3, the controller 11 of the terminal apparatus 10 stores the processing condition accepted in the processing of step SA1, that is, the processing condition specified in the instruction data transmitted in the processing of step SA3, in the memory 15 (step SA6). In this case, the controller 11 stores the processing condition in the memory 15, rather than in the registered condition DB 152, in such a manner that the processing condition is included in the transmission history of the instruction data.

The controller 11 may store the transmission history of instruction data in the memory 15 even if the image forming apparatus 20 does not execute information processing in accordance with the instruction data, or may store the transmission history of the instruction data in the memory 15 only in a case where the image forming apparatus 20 has executed information processing.

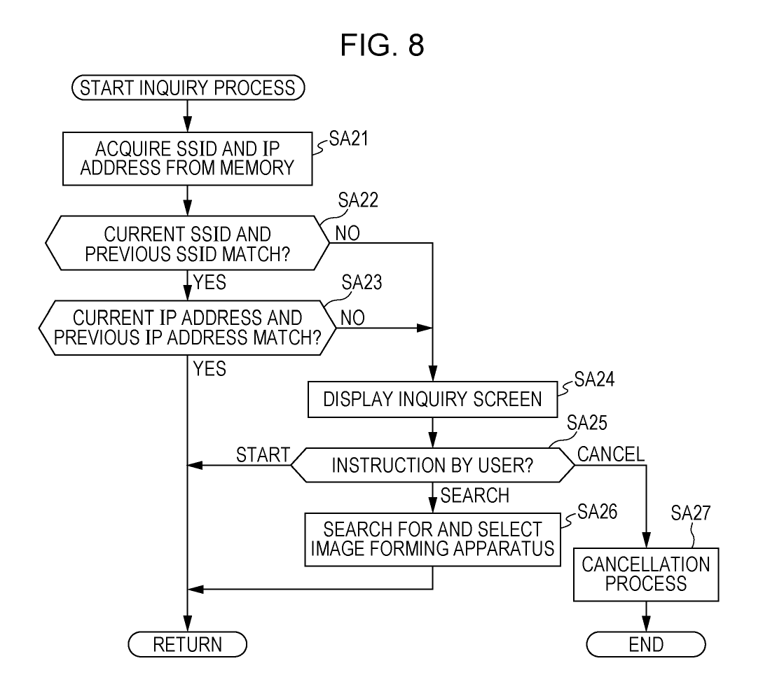

FIG. 8 is a flowchart illustrating the flow for an inquiry process in step SA2.

The controller 11 of the terminal apparatus 10 reads and acquires the SSID 153 and the IP address 154 stored in the memory 15 (step SA21). Then, the controller 11 determines, based on the acquired SSID 153, whether the SSID currently being used to connect to the Wi-Fi network of the communication line 100 coincides with the SSID used in the previous instruction for performing information processing (step SA22). If “YES” is determined in the processing of step SA22, the controller 11 determines, based on the acquired IP address 154, whether the IP address currently assigned to the terminal apparatus 10 coincides with the IP address assigned in the previous instruction for performing information processing (step SA23). If “YES” is determined in the processing of step SA23, the controller 11 ends the inquiry process. In this case, the controller 11 proceeds to step SA3, and transmits the instruction data.

If “NO” is determined in step SA22 or SA23, that is, if the current SSID or IP address is different from the SSID or IP address used in the previous instruction for performing information processing, the controller 11 causes the display 24 to display an inquiry screen (step SA24).

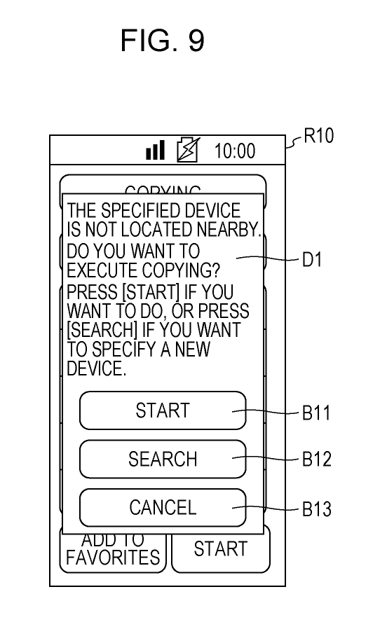

FIG. 9 illustrates an inquiry screen R10 displayed in the processing of step SA24. As illustrated in FIG. 9, the inquiry screen R10 is an operation screen obtained by superimposing a dialog box D1 on the operation screen R1. The dialog box D1 includes a message “The specified device is not located nearby. Do you want to execute copying? Press [Start] if you want to do, or press [Search] if you want to specify a new device.” The dialog box D1 further includes a soft button B11 marked “Start”, a soft button B12 marked “Search”, and a soft button B13 marked “Cancel”.

Upon accepting an operation for selecting the soft button B11 while the inquiry screen R10 is being displayed (step SA25: “Start”), the controller 11 ends the inquiry process, and proceeds to step SA3. In step SA3, the controller 11 transmits instruction data. In this case, since the user accepts the execution of information processing, the controller 11 transmits the instruction data. Upon accepting an operation for selecting the soft button B12 (step SA25: “Search”), the controller 11 searches for a nearby image forming apparatus 20 and prompts the user to select it (step SA26). The controller 11 presents one of the image forming apparatuses 20 that is located near the current position of the terminal apparatus 10 as a candidate for selection using an existing method such as using the IP address assigned to the terminal apparatus 10, and prompts the user to select it. Then, the controller 11 proceeds to step SA3, in which the controller 11 transmits the instruction data to the image forming apparatus 20 selected in the processing of step SA26. Upon accepting an operation for selecting the soft button B13 (step SA25: “Cancel”), the controller 11 performs a cancellation process for canceling the process for transmitting the instruction data (step SA27). For example, the controller 11 does not transmit the instruction data, and returns the current display to the operation screen R1 illustrated in FIG. 5A.

If there is a difference between the SSID or IP address that is currently being used by the terminal apparatus 10 and the SSID or IP address that was used in the previous instruction for performing information processing, it may be probable that the location where the terminal apparatus 10 is located when receiving the current instruction may be different from the location where the terminal apparatus 10 was located when receiving the previous instruction. In this case, in order to avoid the risk of the user inadvertently performing an operation for transmitting the instruction data to the image forming apparatus 20 that is the same as that to which instruction data was sent the previous time to perform information processing using an unintended apparatus, the terminal apparatus 10 informs the user of the risk through the inquiry process in step SA2.

The terminal apparatus 10 further performs a registration process for registering a processing condition that has been specified by the user using the registered condition DB 152. The user performs an operation for registering, for example, a processing condition that will be frequently used in the future.

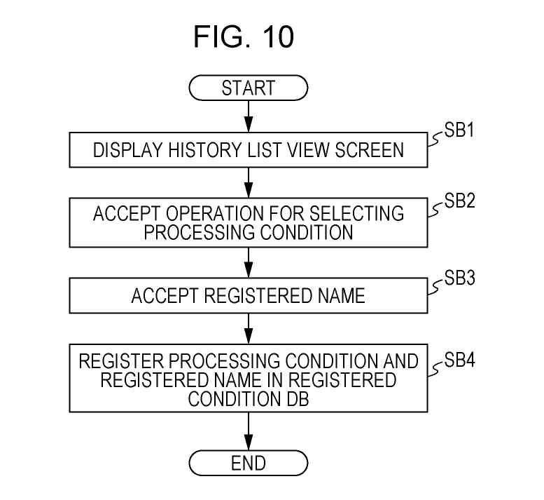

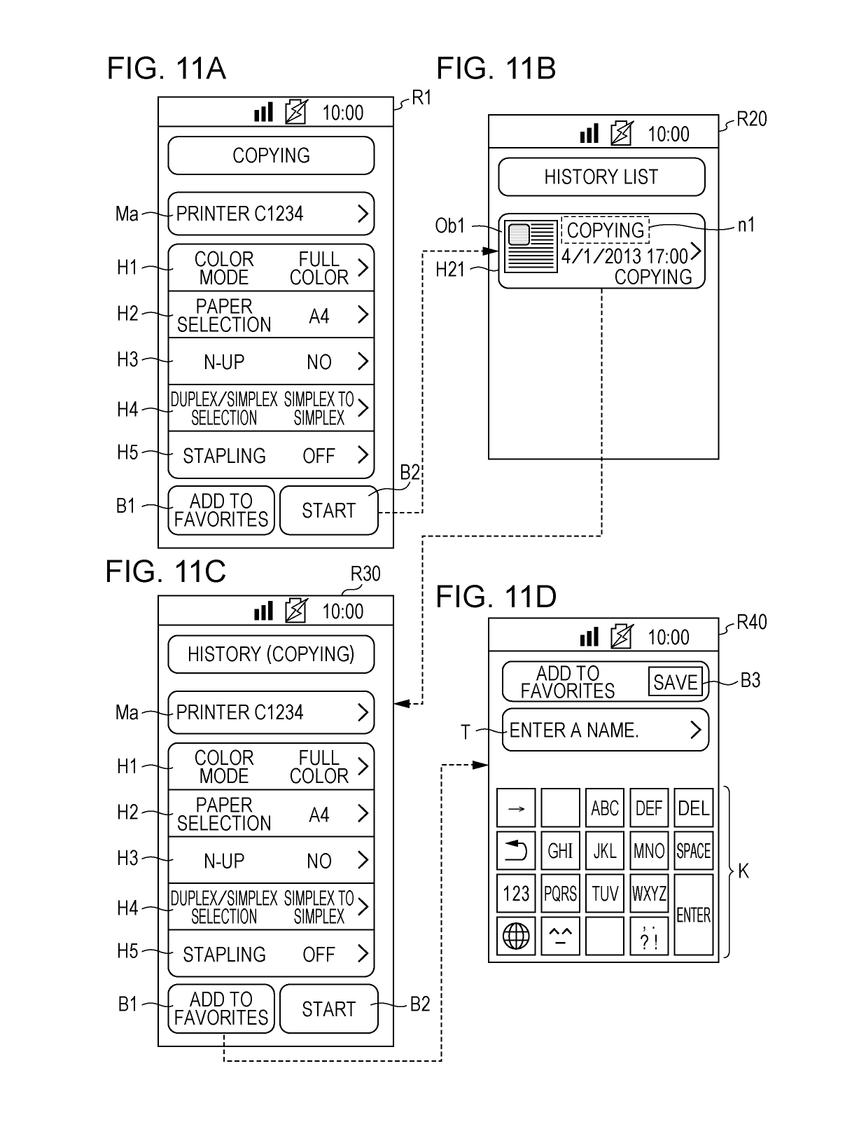

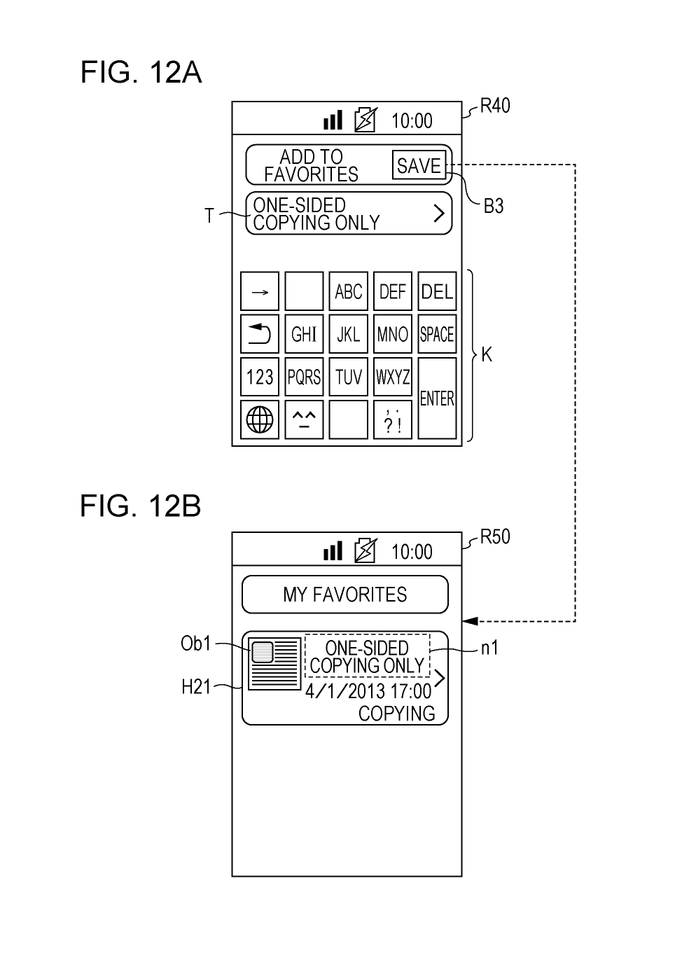

FIG. 10 is a flowchart illustrating the flow for a registration process, which is executed by the terminal apparatus 10. FIGS. 11A to 11D and FIGS. 12A and 12B illustrate transitions of screens in the registration process.

First, the controller 11 of the terminal apparatus 10 causes a list view screen to be displayed in accordance with the transmission history stored in the memory 15 (step SB1). The list view screen is a screen on which the transmission history of processing conditions is displayed in a list view. In a case where the execution of information processing has been instructed in accordance with an operation screen R1 illustrated in FIG. 11A, the controller 11 causes a list view screen R20 illustrated in FIG. 11B to be displayed. By way of example, the list view screen R20 includes a specification field H21. The specification field H21 includes an object image Ob1, the name of a processing condition surrounded by a broken-line frame n1 (in the illustrated example, “Copying”), the date and time of execution of information processing (in the illustrated example, Apr. 1, 2013 17:00), and the type of information processing (in the illustrated example, a copying process). An object image is an image uniquely associated with multiple processing parameters included in a processing condition. That is, object images have different images depending on the combination of processing parameters included in a processing condition. In the illustrated example, as illustrated in FIG. 11A, the object image Ob1 is uniquely associated with a processing condition for which multiple processing parameters have been specified. The name of the processing condition is tentatively set.

Then, the controller 11 of the terminal apparatus 10 accepts the operation for selecting a processing condition by the user using the list view screen (step SB2). By way of example, the controller 11 accepts the operation for, by selecting a specification field included in the list view screen, selecting the processing condition corresponding to the specification field.

Upon accepting the operation for selecting the specification field H21, the controller 11 makes a transition to a history screen R30 illustrated in FIG. 11C. A history screen is a screen on which processing parameters for a processing condition included in a transmission history are displayed. The information included in the history screen R30 is the same as that in the operation screen R1 illustrated in FIG. 11A. In order to register the processing condition, the user touches the soft button B1 marked “Add to favorites” with their finger. Then, the controller 11 makes a transition of the screen from the history screen R30 to an operation screen R40 illustrated in FIG. 11D.

Then, the controller 11 accepts an operation for specifying the registered name of the processing condition (step SB3). The registered name of a processing condition is information to be stored in the field of the registered name associated with the processing condition in the registered condition DB 152. The controller 11 accepts an operation for, for example, inputting characters using an operation area K on the operation screen R40. The operation area K may be an area where a software keyboard which refers to, by way of example, a ten-keyboard (ten-keypad) is displayed, or may be an operation area where a software keyboard with a QWERTY layout is displayed. The controller 11 causes the text input by the user to be displayed in a text display area T. In the example illustrated in FIG. 11D, no registered name has been entered.

As illustrated in FIG. 12A, the registered name “One-sided copying only” is specified, and a soft button B3 marked “Save” is selected by the user. In this case, the controller 11 registers the processing condition and the registered name in the registered condition DB 152 (step SB4). As a result of the registration, the record given in the first row in FIG. 4 is created in the registered condition DB 152. The processing conditions in the second to fourth rows have not yet been registered.

Upon registering the processing condition in the registered condition DB 152, the controller 11 causes a My Favorites screen R50 illustrated in FIG. 12B to be displayed in accordance with the processing condition registered in the registered condition DB 152. A My Favorites screen is a screen on which processing conditions registered in the registered condition DB 152 are displayed as a list. The My Favorites screen R50 is almost the same as the list view screen R20, except that, as surrounded by a broken-line frame n1 in FIG. 12B, the registered name given in the specification field H21 has been changed to the registered name (“One-sided copying only”) specified by the user. This registered name may help the user readily identify what the content of the processing condition looks like.

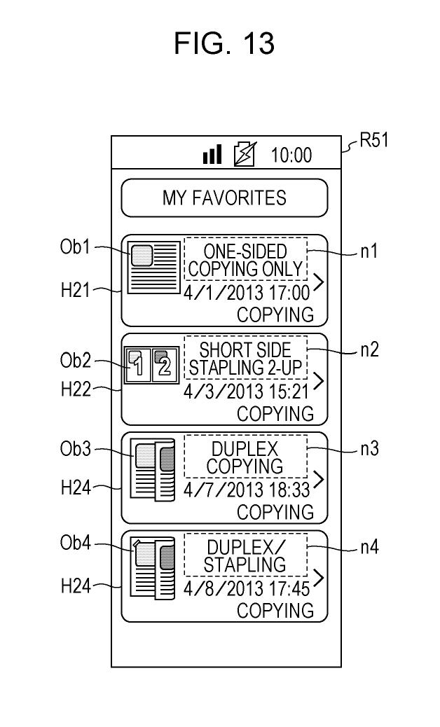

The controller 11 may perform a registration process for registering a processing condition for each of transmission history records included in a list view screen. In a case where the registered condition DB 152 having the configuration illustrated in FIG. 4 is stored in the memory 15, the controller 11 causes a My Favorites screen R51 illustrated in FIG. 13 to be displayed on the display 14. On the My Favorites screen R51, specification fields H21 to H24 corresponding to four processing conditions in total are displayed. Since the processing conditions corresponding to the specification fields H21 to H24 are different, object images Ob1 to Ob4 are also different. In addition, the respective registered names of the processing conditions are surrounded by broken lines n1 to n4, and are set to names that help the user readily identify the content of the respective processing conditions.

In the illustrated example, the controller 11 registers a processing condition in the registered condition DB 152 in accordance with the transmission history of instruction data for information processing. In addition, a processing condition may be registered in the registered condition DB 152 when the soft button B1 is selected on the operation screen R1 illustrated in FIG. 5A. That is, the controller 11 has a function for performing a registration process for registering a processing condition including processing parameters specified directly by the user.

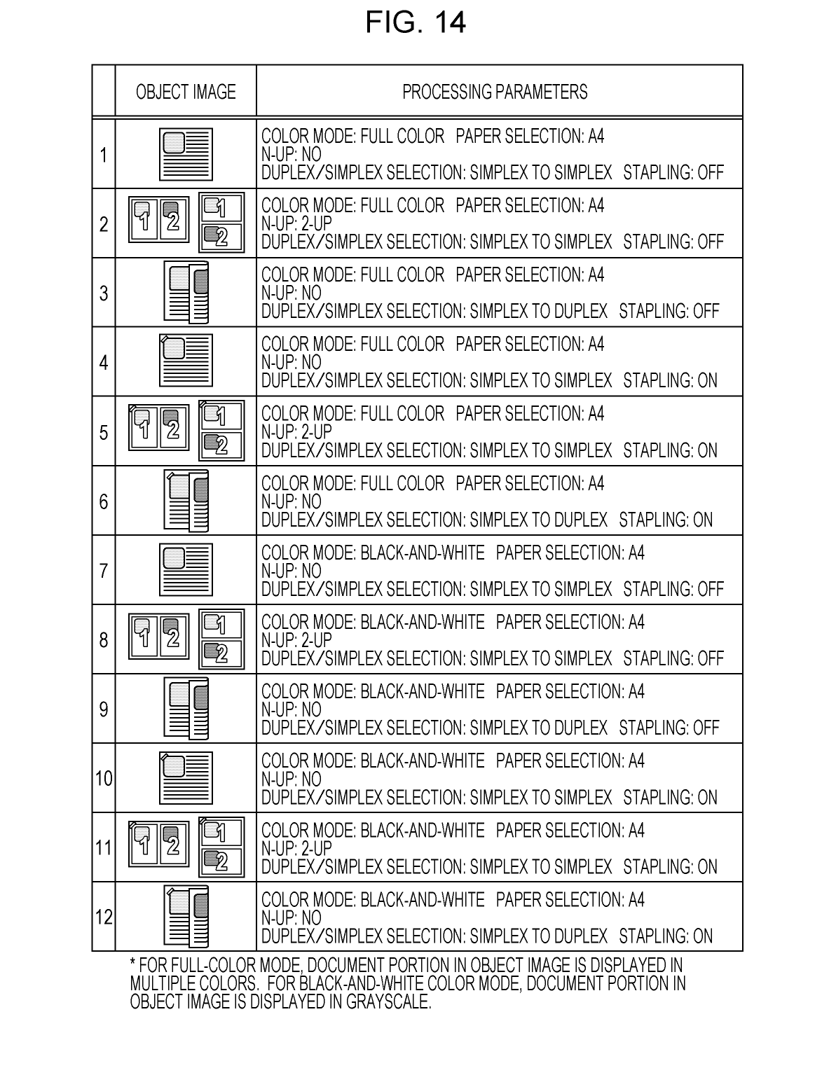

FIG. 14 illustrates the relationships between object images and processing parameters according to this exemplary embodiment. The terminal apparatus 10 according to this exemplary embodiment causes the object images illustrated in FIG. 14 to be displayed on a list view screen or a My Favorites screen in accordance with processing parameters included in processing conditions. As illustrated in FIG. 14, the processing conditions given in the first to twelfth rows are different, and the associated object images are also different. That is, the objects differ in accordance with the processing parameters included in the respective processing conditions, and the same object image is not used for different processing conditions. In this exemplary embodiment, object images are based on processing parameters under certain rules. In the illustration in FIG. 14, two object images are given for some processing conditions, in which case the processing parameter for N-up is 2-up. The object image illustrated in the left portion is used for portrait documents, and the object image illustrated in the right portion is used for landscape documents.

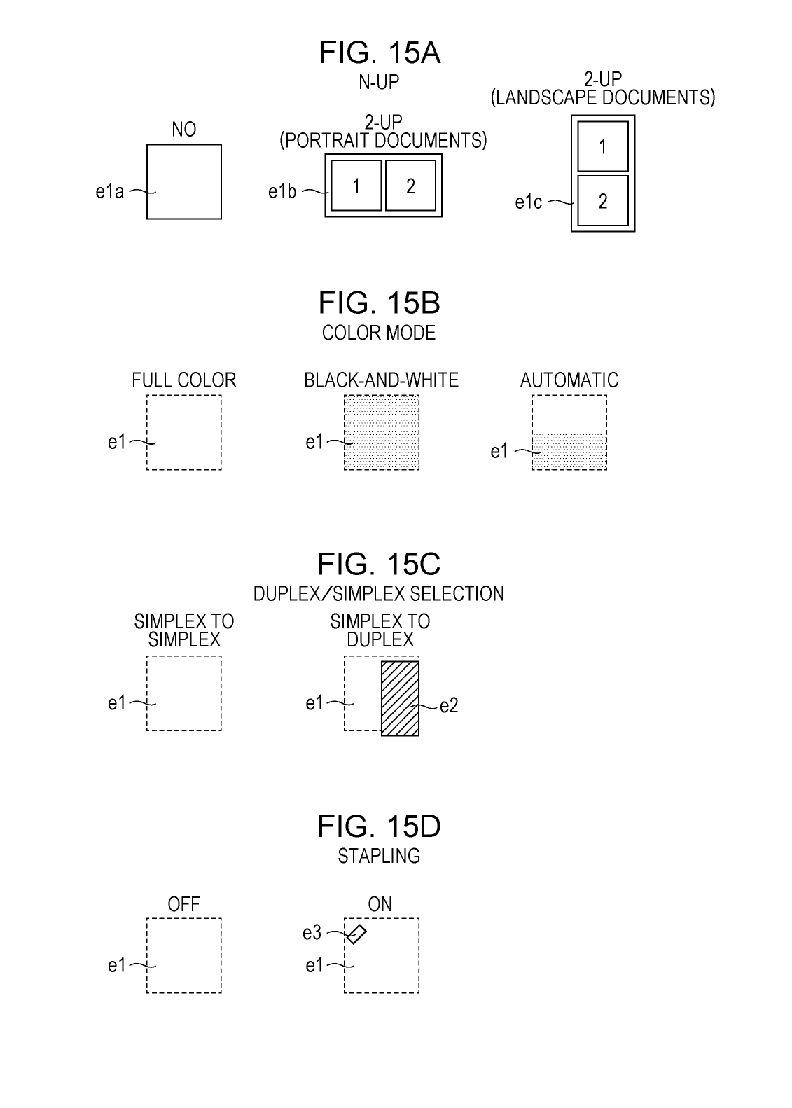

FIGS. 15A to 15D illustrate display elements included in object images.

As illustrated in FIG. 15A, an object image according to this exemplary embodiment includes one of display elements e1a, e1b, and e1c that represent layouts of a document or documents. The display element e1a is used for the processing parameter “no N-up”. The display element e1b is used for the N-up setting of “2up/portrait documents”. The display element e1c is used for the N-up setting of “2up/landscape documents”. In the following description, the display elements eta, e1b, and e1c are collectively referred to as “display elements e1” unless they are individually identified. The display elements e1 are display elements that are symbolic of processing parameters for N-up. Other processing parameters for N-up are associated with different display elements for respective processing parameters, which will not be described herein.

As illustrated in FIG. 15B, the colors of object images differ depending on the processing parameters concerning the color mode. As illustrated in FIG. 15B, if the color mode is set to “full color”, the object image is displayed in multiple colors. If the color mode is set to “black and white”, the object image is displayed in grayscale. If the color mode is set to “automatic”, the upper half of the object image is represented in multiple colors, and the lower half thereof is represented in grayscale. That is, the colors to be used for object images are display elements that are symbolic of processing parameters for “color mode”. In the “black and white” and “automatic” color modes, for example, the number portion in a document when placed 2-up may be represented in multiple colors, and the other portion may be represented in black and white.

As illustrated in FIG. 15C, the presence or absence of a display element e2 differs depending on the processing parameter of the duplex/simplex selection. As illustrated in FIG. 15C, if the duplex/simplex selection is set to “simplex to duplex”, the display element e2 is added to part of the right portion of the display element e1. As may be seen from the first and third rows in FIG. 14, the display element e1, which represents the front side of a document, is used for “simplex to simplex”, and the display element e2, which represents the rear side of a document, is added to the display element e1 to indicate “simplex to duplex”. That is, the display element e2 is a display element that is symbolic of processing parameters for duplex/simplex selection. Other processing parameters for duplex/simplex selection are associated with display elements different for respective processing parameters, which will not be described herein.

As illustrated in FIG. 15D, the presence or absence of a display element e3 differs depending on the processing parameter of stapling. As illustrated in FIG. 15D, if stapling is set to “ON”, the display element e3 is added to an upper left portion of the display element e1. As may be seen from the first and tenth rows in FIG. 14, the display element e1, which represents the front side of a document, is used for stapling “OFF”, and the display element e3, which looks like a staple, is added to the display element e1 to indicate stapling “ON”. That is, the display element e3 is a display element that is symbolic of processing parameters for stapling.

As described above, an object image according to this exemplary embodiment is formed by combining display elements uniquely associated with the respective processing parameters. Thus, object images are different depending on each processing condition.

Although the relationships between the processing parameters for paper selection and display elements will not be described, it is to be understood that the respective processing parameters are associated with different display elements.

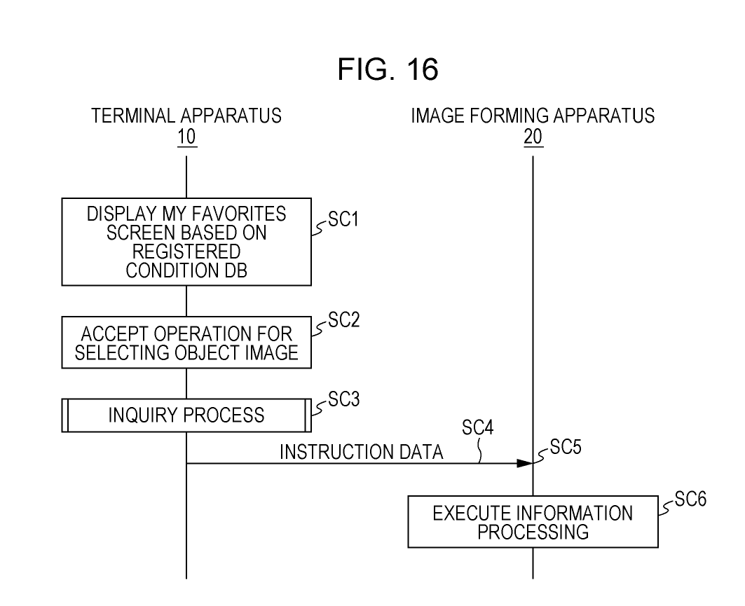

FIG. 16 is a sequence diagram illustrating the flow for processing performed in the information processing system 1 in a case where the terminal apparatus 10 instructs the image forming apparatus 20 to execute a copying process through a My Favorites screen. In the following description, at the start of the operation, the registered condition DB 152 has the configuration illustrated in FIG. 4.

First, the controller 11 of the terminal apparatus 10 refers to the registered condition DB 152 in accordance with, for example, a user operation, and causes the My Favorites screen to be displayed on the display 14 (step SC1). In this case, the controller 11 causes the My Favorites screen R51 illustrated in FIG. 13 to be displayed so that object images uniquely associated with processing parameters for each of the processing conditions included in the registered condition DB 152 are displayed. Then, the controller 11 accepts an operation for selecting an object image on the My Favorites screen (step SC2). Upon accepting an operation for selecting an object image, the controller 11 executes an inquiry process (step SC3). The inquiry process may be substantially the same as that in step SA2, and a specific processing procedure thereof is similar to that described with reference to FIG. 8.

If information processing is to be executed after the inquiry process, the controller 11 specifies multiple processing parameters for the processing condition corresponding to the object selected in the processing of step SC3 in accordance with the registered condition DB 152, and transmits instruction data to the image forming apparatus 20 to execute information processing in accordance with the specified processing condition (step SC4). The instruction data may include any other information such as the registered name of the processing condition. For example, the registered name of the processing condition may be included in the history of execution of information processing which is stored in the image forming apparatus 20.

Upon receiving the instruction data at the communication unit 23 (step SC5), the controller 21 of the image forming apparatus 20 executes information processing instructed to be executed in accordance with the received instruction data (step SC6).

While the operation of the information processing system 1 has been described in the context of a copying process by way of example, a scanning process or a facsimile transmission process may also be performed. Also in this case, the registration and use of a processing condition may be performed using the procedure described above although processing parameters included in the processing condition are different.

In the information processing system 1 according to the exemplary embodiment described above, the terminal apparatus 10 registers a processing condition including multiple processing parameters that have been directly specified by a user, and subsequently receives an operation for specifying a processing condition through an operation for selecting an object image uniquely associated with multiple processing parameters included in the processing condition. In this case, the terminal apparatus 10 causes an object image having a combination of display elements corresponding to the respective processing parameters to be displayed so that the user may visually identify the respective processing parameters. Such an object image may allow the user to understand a processing condition without, for example, checking its detailed processing parameters. In addition, object images are formed by arranging display elements that differ from one processing parameter to another in accordance with the rules described with reference to FIGS. 15A to 15D. Accordingly, display elements included in an object image may help the user understand the associated processing condition.

Furthermore, the terminal apparatus 10 performs an inquiry process, thereby informing the user that instruction data will be transmitted to the image forming apparatus 20 that is the same as that used in the previous instruction although the user is now in a different position.

The present invention may be carried out in ways different from those in the foregoing exemplary embodiment. In addition, the following exemplary modifications may be combined.

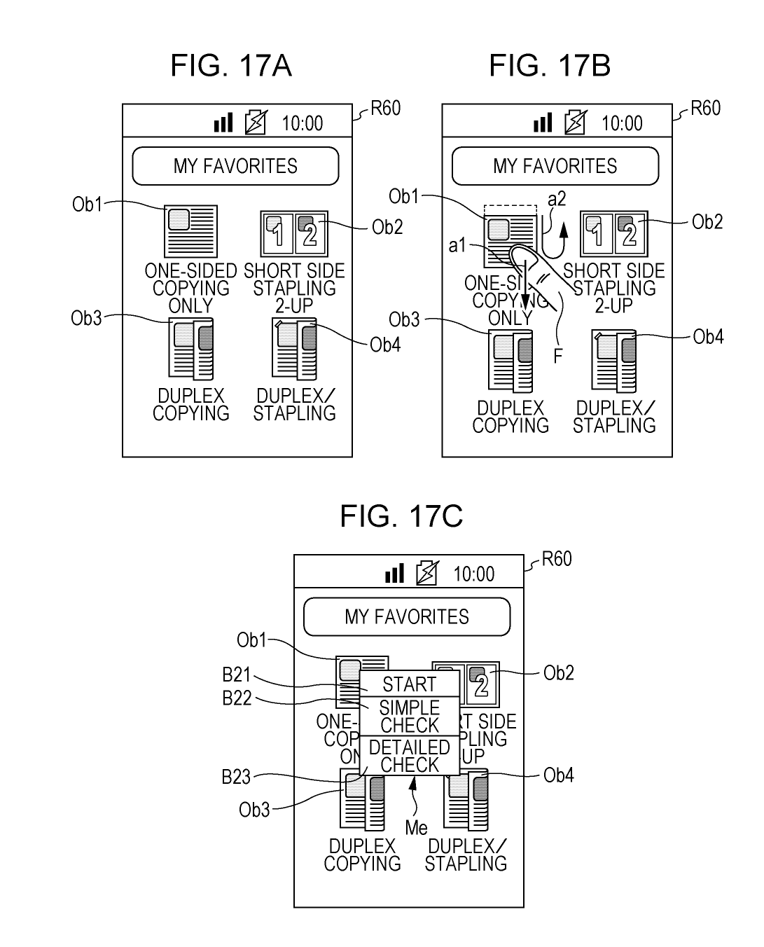

A My Favorites screen may be displayed in, by way of example, but not limited to, the display form illustrated in FIG. 13 in which specification fields are arranged from the top to the bottom. For example, the terminal apparatus 10 may cause a My Favorites screen R60 illustrated in FIGS. 17A to 17C to be displayed, and may execute different processes depending on the way in which an object image is selected.

FIGS. 17A to 17C illustrate the My Favorites screen R60. The My Favorites screen R60 illustrated in FIG. 17A is displayed in a case where the registered condition DB 152 has the configuration illustrated in FIG. 4. As illustrated in FIG. 17A, in this exemplary modification, object images Ob1 to Ob4 associated with respective processing conditions are displayed in enlarged scale compared to those in the example illustrated in FIG. 13, and registered names are given below the respective object images. A user who wishes to specify a processing condition and instruct that information processing be executed touches the corresponding object image with their finger, called a tap operation. The terminal apparatus 10 accepts the tap operation as the operation in step SC2. The subsequent operation of the information processing system 1 is similar to that described with reference to FIG. 16.

Furthermore, as illustrated in FIG. 17B, the controller 11 of the terminal apparatus 10 according to this exemplary modification performs an operation for causing the user to slide an object image (in the illustrated example, Ob1) down (in the direction indicated by an arrow a1) while touching the object image with a finger F (called a swipe operation), and, as indicated by an arrow a2, to slide the object image Ob1 up after sliding it down to return to the original position. Then, as illustrated in FIG. 17C, the controller 11 causes a menu list Me to be displayed in association with the selected object image. The menu list Me includes an option B21 marked “Start”, an option B22 marked “Simple check”, and an option B23 marked “Detailed check”. The menu list Me includes options associated with individual types of processes that use a processing condition corresponding to the object image.

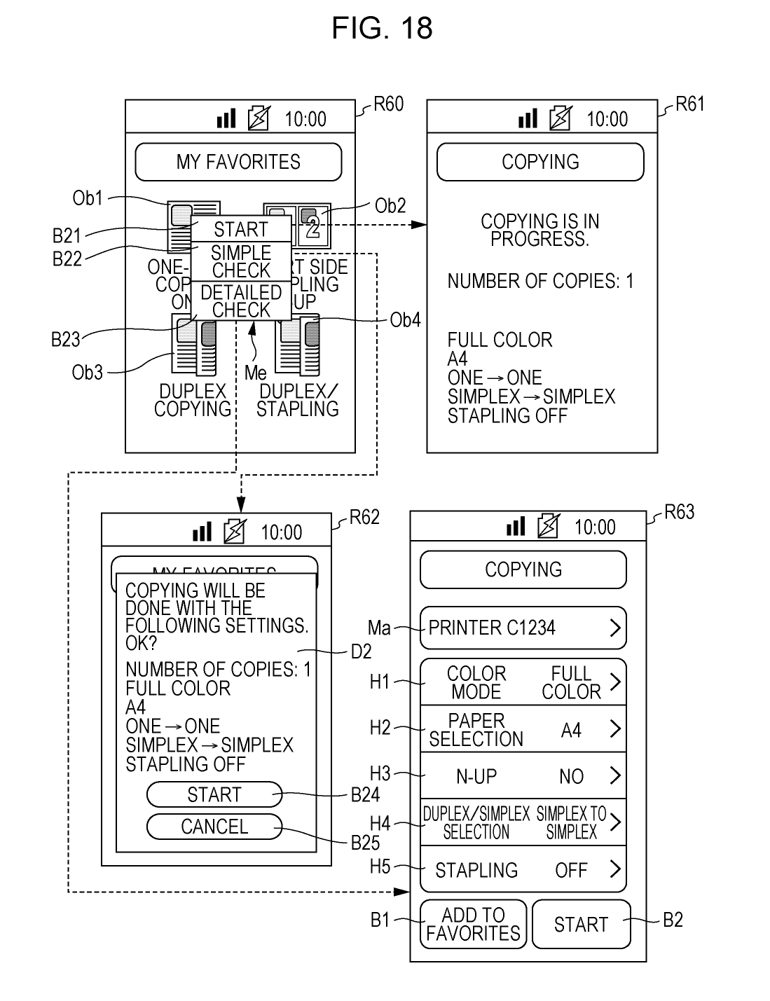

FIG. 18 illustrates the relationships between the options of the menu list Me and processes to be executed. As illustrated in FIG. 18, if the option B21 is selected, the controller 11 makes a transition to an execution screen R61, and immediately transmits instruction data for executing information processing in accordance with the processing condition corresponding to the object image to the image forming apparatus 20 (that is, executes the processing corresponding to step SC4). The execution screen R61 is a screen indicating that the execution of information processing has initiated or indicating a processing condition specified by the instruction data.

If the option B22 is selected (“first operation”), the controller 11 causes a confirmation screen R62 for the processing condition corresponding to the object image to be displayed. The confirmation screen R62 is a screen obtained by superimposing a dialog box D2 on the My Favorites screen R60. The dialog box D2 includes a message indicating that instruction data is to be transmitted and indicating the processing condition, a soft button B24 marked “Start”, and a soft button B25 marked “Cancel”. A user checks the processing condition and so forth, and selects the soft button B24 to start the execution of information processing or selects the soft button B25 to cancel the execution of information processing. If the soft button B24 is selected, the controller 11 immediately transmits instruction data for executing information processing to the image forming apparatus 20. If the soft button B25 is selected, the controller 11 cancels the execution of information processing, and returns the display to, for example, the My Favorites screen R60 illustrated in FIG. 17A.

If the option B23 is selected (“second operation”), the controller 11 causes a modification screen R63 for the processing condition corresponding to the object image to be displayed. The modification screen R63 is a screen used to accept modifications to the processing condition corresponding to the object image, and is the same as the operation screen R1 illustrated in FIG. 5A. The controller 11 accepts modifications to the processing condition while the modification screen R63 is being displayed. When the soft button B2 is selected, the controller 11 transmits instruction data for executing information processing in accordance with the modified processing condition.

In the illustrated example, the menu list Me is displayed in response to a swipe operation. Alternatively, the terminal apparatus 10 may display the menu list Me in response to a predetermined operation such as consecutive taps of an object image (for example, two consecutive presses) or a press-and-hold (for example, a continuous press for three seconds).

Also in the above exemplary modification, the controller 11 may execute an inquiry process before the transmission of instruction data.

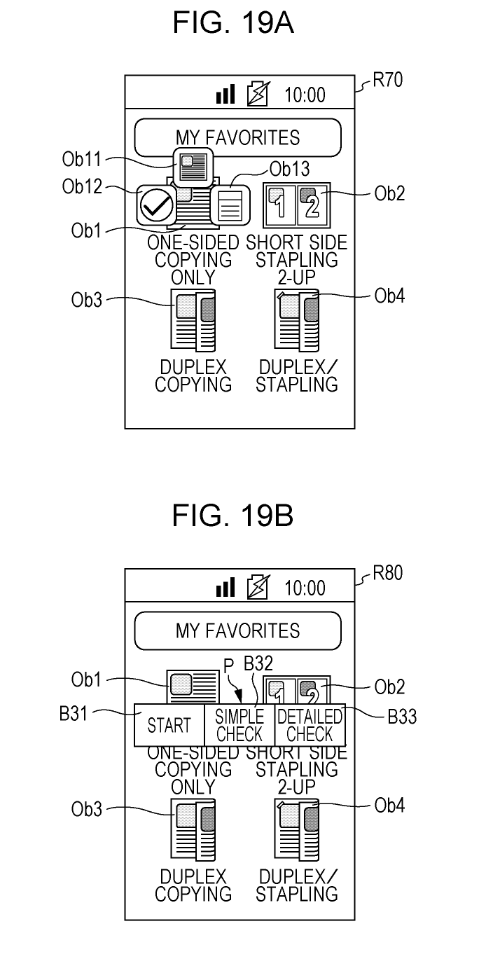

In addition, as illustrated in FIGS. 19A and 19B, the terminal apparatus 10 may display a screen that prompts the user to specify a processing condition using a display form other than the menu list Me. As illustrated in FIG. 19A, the controller 11 may cause object images to be displayed instead of the menu list Me. In the example illustrated in FIG. 19A, object images Ob11 to Ob13 are displayed in association with the object image Ob1. The operations of the terminal apparatus 10 when the object images Ob11, Ob12, and Ob13 are selected may be the same as those when the options B21, B22, and B23 in the menu list Me are selected, respectively. In this case, desirably, the object images Ob11 to Ob13 are images that help the user identify the processes to be executed by the terminal apparatus 10 when they are selected.

As illustrated in FIG. 19B, the controller 11 may also cause a pop-up window P to be displayed instead of the menu list Me. In the example illustrated in FIG. 19B, options B31, B32, and B33 are displayed in association with the object image Ob1. The operations of the terminal apparatus 10 when the options B31, B32, and B33 are selected may be the same as those when the options B21, B22, and B23 in the menu list Me are selected, respectively.

Various screens displayed on the terminal apparatus 10 described in the foregoing exemplary embodiment and the operations made by the user using the screens are merely examples, and the design of the screens and the methods for the operations to be made by the user using the screens are not limited to the examples described in the exemplary embodiment.

Still other processes may be performed as processes to be executed in response to the selection of objects. Examples of the processes may include displaying a preview screen of an image that has undergone a copying process, and displaying, when transmitting image data and performing an image forming process, attribute information (for example, creation date and time) on the image data.

In the terminal apparatus 10 according to the exemplary embodiment described above, processing parameters and registered names are associated with one another in the registered condition DB 152. Destination information concerning the image forming apparatus 20 to which instruction data is transmitted may further be associated.

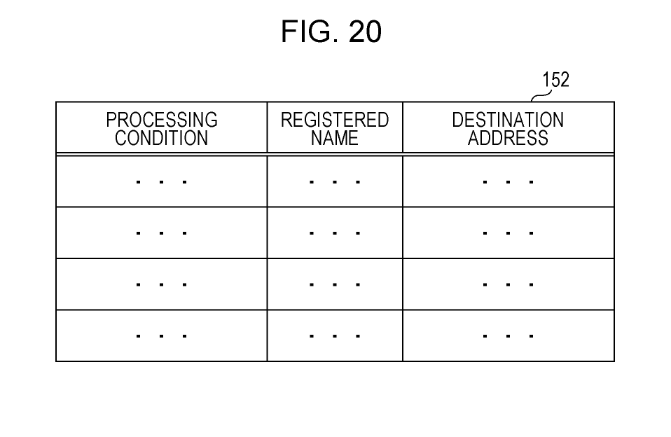

FIG. 20 illustrates a configuration of a registered condition DB 152 according to this exemplary modification. A destination address stored in the registered condition DB 152 may be the IP address assigned to the image forming apparatus 20 to which instruction data is transmitted.

With the configuration described above, the terminal apparatus 10 transmits and outputs instruction data for specifying a processing condition associated with the destination address to the image forming apparatus 20 using the destination address stored in the registered condition DB 152.

The terminal apparatus 10 according to this exemplary modification is configured to register processing conditions in such a manner that the processing conditions are sorted by the image forming apparatuses 20 to be used, and may thus be suitable for the case where, for example, the settings of a processing condition are made different depending on the image forming apparatus 20. One possible use may be, for example, to set the color mode to “full color” all the time in an office where the user typically works while setting the color mode to “black and white” all the time in an office while on a business trip to save toner.

In this exemplary modification, destination information other than the IP address of the terminal apparatus 10 may be registered in the registered condition DB 152 in association with a processing condition.

The terminal apparatus 10 may be configured to display object images in such a manner that the object images differ depending on at least the combination of multiple processing parameters included in a processing condition. That is, the terminal apparatus 10 may be configured to display object images other than an object image in which display elements uniquely associated with the respective processing parameters are combined.

The terminal apparatus 10 according to the exemplary embodiment described above is configured to perform an inquiry process to compare the SSID or IP address used in the previous instruction for performing information processing with the SSID or IP address used in the current instruction for performing information processing. Alternatively, for example, different SSIDs 153 and different IP addresses 154 may be used for the respective processing conditions stored in the registered condition DB 152. Furthermore, the terminal apparatus 10 may perform an inquiry process using one of the SSID 153 and the IP address 154, or may not necessarily execute an inquiry process.

The terminal apparatus 10 may not necessarily perform a registration process for registering a processing condition in the registered condition DB 152. For example, upon accepting an operation for selecting a specification field including an object image arranged in a list view screen (see FIG. 11B), the terminal apparatus 10 may transmit instruction data for executing information processing in accordance with the processing condition corresponding to the object image to the image forming apparatus 20.

In the exemplary embodiment described above, the configuration of a portion of instruction data that serves as a transmission history may be replaced with a history of execution of information processing based on the instruction data. In this case, the terminal apparatus 10 transmits instruction data, and then receives a notification as to whether the execution of information processing based on the instruction data has succeeded or failed from the image forming apparatus 20. Then, the terminal apparatus 10 may also display a processing condition indicating instruction data used for information processing that has succeeded in a list view screen.

The processing parameters described in the exemplary embodiment described above are merely examples. For example, processing parameters concerning image quality, such as the resolution at which an image is read by the image reading unit 25, the file format of image data to be generated, and the density of an image formed by the image forming unit 26, may be included, or processing parameters concerning post-processing, such as punching a hole in a recording medium and stacking or rearranging recording media, may be included.

In the exemplary embodiment described above, an information processing apparatus according to an exemplary embodiment of the present invention has been described using the image forming apparatus 20. However, an information processing apparatus according to an exemplary embodiment of the present invention may not necessarily have a function for forming an image. An information processing apparatus according to an exemplary embodiment of the present invention may be any device configured to execute information processing specified by directly operating the information processing apparatus and to execute information processing specified by operating a terminal apparatus, and is not limited to any specific information processing apparatus. Therefore, an information processing apparatus according to an exemplary embodiment of the present invention may be an information processing apparatus such as a personal computer.

In the exemplary embodiment described above, a terminal apparatus according to an exemplary embodiment of the present invention has been described using the terminal apparatus 10. However, a terminal apparatus according to an exemplary embodiment of the present invention may be applied to the image forming apparatus 20. In this case, the controller 21 of the image forming apparatus 20 may register a processing condition specified directly by a user in a registered condition DB stored in the memory 27. The registered condition DB may have substantially the same configuration as that of the registered condition DB 152 described above. In this case, the controller 21 of the image forming apparatus 20 causes an object image associated with the processing condition to be displayed in accordance with the registered condition DB stored in the memory 27. Further, the controller 21 may output instruction data for causing the individual units of the image forming apparatus 20 to perform information processing so as to execute the information processing in accordance with the processing condition corresponding to the object image specified by the user. That is, an exemplary embodiment of the present invention may not necessarily provide a configuration for instructing that information processing be executed by remote operation.

The communication line 100 may be a communication line including a communication path other than a wireless LAN or a Wi-Fi network, or may be a wireless communication line, a wired communication line, or a combination of wireless and wired communication lines.

The functions implemented by the terminal apparatus 10 and the image forming apparatus 20 according to the exemplary embodiment described above may be implemented by one or more hardware circuits or by executing one or more programs using a computing device, or may be implemented by a combination thereof.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A terminal apparatus comprising:
an acceptance unit that accepts an operation;
a memory that stores a reading condition for executing a reading process;
a display that displays a plurality of icons for an individual reading condition, the plurality of icons representing the individual reading condition; and
a transmitter that transmits, in a case where the acceptance unit accepts an operation for selecting one of the plurality of icons, instruction data for instructing that a reading process be performed under the reading condition corresponding to the selected icon to an external reading apparatus which is to execute the reading process.

2. The terminal apparatus according to claim 1, wherein
the reading condition is accepted by the acceptance unit, and includes a plurality of processing parameters, and
the display displays an object image for an individual reading condition, the object image being uniquely associated with a plurality of processing parameters included in the individual reading condition.

3. The terminal apparatus according to claim 2, wherein the display displays the object image in such a manner that display elements each uniquely associated with one of the plurality of processing parameters are combined.

4. The terminal apparatus according to claim 2, wherein
the acceptance unit accepts a first operation and a second operation as operations for selecting the object image that is displayed, the first operation and the second operation being determined in advance,
the display displays
a confirmation screen for the reading condition corresponding to the object image in a case where the first operation is accepted by the acceptance unit, and
a modification screen for the reading condition corresponding to the object image in a case where the second operation is accepted by the acceptance unit, and
the acceptance unit accepts an operation for modifying the reading condition while the modification screen is being displayed.

5. The terminal apparatus according to claim 1, wherein
the memory stores destination information on an information processing apparatus to which the instruction data is output in association with the reading condition specified in the instruction data, the information processing apparatus being a reading processing apparatus that executes the reading process, and
the transmitter transmits the instruction data to the reading processing apparatus using the destination information stored in the memory, the instruction data specifying the reading condition associated with the destination information.

6. The terminal apparatus according to claim 1, further comprising:
an acquisition unit that acquires identification information identifying a position of the terminal apparatus or a communication address which varies in accordance with the position of the terminal apparatus; and
an inquiry unit that inquires of a user, based on the identification information or communication address acquired by the acquisition unit, whether output of the instruction data is acceptable in a case where identification information or a communication address assigned when the first operation is accepted is different from identification information or a communication address assigned when the first operation was accepted the previous time, wherein
the transmitter transmits the instruction data in a case where the acceptance unit accepts an operation for permitting the instruction data to be output in response to an inquiry made by the inquiry unit.

7. The terminal apparatus according to claim 5, further comprising:
an acquisition unit that acquires identification information identifying a position of the terminal apparatus or a communication address which varies in accordance with the position of the terminal apparatus; and
an inquiry unit that inquires of a user, based on the identification information or communication address acquired by the acquisition unit, whether output of the instruction data is acceptable in a case where identification information or a communication address assigned when the first operation is accepted is different from identification information or a communication address assigned when the first operation was accepted the previous time, wherein
the transmitter transmits the instruction data in a case where the acceptance unit accepts an operation for permitting the instruction data to be output in response to an inquiry made by the inquiry unit.

8. The terminal apparatus according to claim 1, wherein the memory stores the reading condition specified in the instruction data.

9. A non-transitory computer readable medium storing a program causing a computer to execute a process, the process comprising:
accepting an operation;
storing a reading condition for executing a reading process;
displaying a plurality of icons for an individual reading condition, the plurality of icons representing the individual reading condition; and
upon accepting an operation for selecting one of the plurality of icons, transmitting instruction data for instructing that a reading process be performed under the reading condition corresponding to the selected icon to an external reading apparatus which is to execute the reading process.

10. A reading processing system comprising:
a terminal apparatus; and
a reading apparatus,
the terminal apparatus including
an acceptance unit that accepts an operation,
a memory that stores a reading condition for executing a reading process,
a display that displays a plurality of icons for an individual reading condition, the plurality of icons representing the individual reading condition, and
a transmitter that transmits, in a case where the acceptance unit accepts an operation for selecting one of the plurality of icons, instruction data for instructing that a reading process be performed under the reading condition corresponding to the selected icon to the reading apparatus so that the reading apparatus executes the reading process,
the reading apparatus including
a receiving unit that receives the instruction data transmitted from the transmitter, and
an execution unit that executes the reading process in accordance with the reading condition specified by the instruction data received by the receiving unit.
